(19) United States
(12) Patent Application Publication
(10) Pub. No.: US 2009/0097418 A1
(43) Pub. Date: Apr. 16, 2009

(54) System and method for network service path analysis

(75) Inventors: Roger Castillo, Austin, TX (US); Stephen Bayer, Austin, TX (US)

Correspondence Address: ANTHONY EDW. J CAMPBELL, PO BOX 160370, AUSTIN, TX, 78716, US

(73) Assignee: AlterPoint, Inc., Austin, TX (US)

(21) Appl. No.: 11/974,107

(22) Filed: Oct. 11, 2007

(51) Int. Cl. H04L 12/28

(52) U.S. Cl. 370/255

(57) ABSTRACT

Systems and methods for network service path analysis analyze and manage the delivery of applications over a network. A program running on a computer utilizes a Layer 3 topology of a computer network to create a directed graph representing deliverability of packets across the network. By analyzing access control lists and firewall rule sets from the network, along with modeling routing protocol behavior and policy as packet filters, the program performs a series of matrix multiplications, using an optimized decomposition of the IP packet space. The resulting matrix contains all of the path information for all deliverable packets. The matrix populates a network path database that captures the set of packets deliverable between any pair of Internet Protocol addresses in the network.

### FIELD OF THE INVENTION

The present invention relates to a system and method for network service path analysis for use in connection with network and IT management. The system and method for network service path analysis has particular utility in connection with analyzing and managing the delivery of applications over a network.

### BACKGROUND OF THE INVENTION

Systems and methods for network service path analysis are desirable for analyzing and managing the delivery of applications over a network. Service management approaches have been limited in information technology in large part because of the complexity of understanding the way applications are delivered to users over computer networks. Given the complicated and distributed nature of the network's operations, no complete picture has existed of how specifically applications and users are connected via the network. Current network management solutions have attempted to approximate this picture through user input, application mapping/discovery, and application traffic analysis. The present invention is a new approach to analyzing and managing the delivery of applications over a network by identifying all of the network paths available for application traffic to reach end-customers through the static analysis of network configuration. This path between application source and customer destination is the network service path. Through service path analysis, the focus of network management moves from the individual network element to managing end-to-end network service path delivery.

It is only during the last 5 years that several critical advances in network management have come together to make network service path analysis possible. The key challenges to service path analysis include:
The lack of configuration standards has inhibited deep configuration analysis.
Industry has not focused on the network management research.
Until 2005 (Xie, et al), there existed no way to statically analyze the reachability of an IP network.

Given recent advancements in network research and network configuration and network connectivity analysis, the present invention enables network service path analysis that computes all paths available to a given application's traffic within a network.

The uses of network reachability and network graph analysis are both known in the prior art. For example, a standard mathematical representation for a computer network is a graph of nodes. Mathematically, a graph is a set of vertices, with a set of edges joining one or more pairs of the vertices. Visual representations of network graphs of computer networks are commonly used in design and network monitoring tools where the vertices are portrayed by icons, representing various types of network devices, and the edges as lines connecting the icons (FIG. 1). In this type of visualization the edges are “undirected.” Packets are presumed to be deliverable in either direction.

This visualization, however, hides three important facts about the operation of the network. First, while at the physical layer information may be transmitted across links in either direction, the configuration of network device interfaces distinguish between inbound and outbound packet flows. Thus a complete representation of the network connectivity is as a directed graph (also known as a digraph) where each vertex is connected by two edges, one in each direction. Second, the routing configuration of the network will restrict the forwarding of packets through some edges (interfaces), but not others. Finally, the configuration of packet filters on device interfaces (as well as the operation of firewalls) will block the delivery of packets based on values found in the IP header fields. The commonly used visual representation of network connectivity as a single undirected edge hides the fact that networks maybe selectively connected in either direction and traffic maybe selective delivered, depending on configuration.

In a generic directed graph, reachability is usually computed by the application of Warshall's algorithm, for which one creates a Boolean “adjacency” matrix, with a row and column for each vertex, each element initialized with the value “true” if the graph contains an edge from the vertex associated with the row to that associated with the column, and otherwise with “false”. Then through multiplications of the matrix with itself, the reachability of all ordered pairs of vertices is determined.

Geoffrey Xie and researchers from Carnegie Mellon University and AT&T Labs have extended the Warshall algorithm to compute the reachability of network (network reachability) routing elements in the presence of routing protocols and packet filters. Their algorithm, however, entails prohibitively costly scaling problems when applied to even moderately sized enterprise networks. In large enterprise networks is not uncommon to encounter network device counts of up to 100,000 and rule-sets comprised of thousand packet filter rules on a single device.

The use of apparatuses and methods for analyzing graphs is known in the prior art. For example, U.S. Pat. No. 6,941,236 to Huelsbergen et al. discloses an apparatus and methods for analyzing graphs. However, the Huelsbergen et al. '236 patent does not attempt to take an optimal approach, and has further drawbacks of lacking scalability.

United States Patent Application Publication Number 2005/0102423 to Pelavin et al. discloses analyzing an access control list for a router to identify a subsumption relation between elements in the list that identifies computer network integrity violations. However, the Pelavin et al. 2005/0102423 patent application publication does not reduce access control lists to mathematical processes, and additionally does not engage in set-based processing.

Similarly, U.S. Pat. No. 6,744,727 to Liu et al. discloses an apparatus and method for spare capacity allocation that derives a backup path routing spare capacity template. However, the Liu et al. '727 patent does not compute topology, and does not identify links.

In addition, U.S. Pat. No. 6,842,427 to Evslin et al. discloses a method and apparatus for optimizing transmission of signals over a packet switched data network that optimizes routing through a data network. However, the Evslin et al. '427 patent does not function without assuming the optimal path is known.

Furthermore, U.S. Pat. No. 6,912,203 to Jain et al. discloses a method and apparatus for estimating delay and jitter between many network routers using measurements between a preferred set of routers that determines a network performance metric in a network. However, the Jain et al. '203 patent does not compute topology, and further lacks the ability to address specific paths.

U.S. Pat. No. 6,411,922 to Clark et al. discloses problem modeling in resource optimization that examines a user information resource and transforms data objects and object relationships from the resource and to optimization metrics for storage in a problem solver database. However, the Clark et al. '922 patent does not identify all the network paths available for application traffic to reach end-customers through the static analysis of network configuration.

In addition, Patent Application Publication Number WO 2005/064850 to Canright et al. discloses a method for managing networks by analyzing connectivity that determines the ability of a network to spread information or physical traffic. However, the Canright et al. WO 2005/064850 patent does not use link weight or actual traffic to analyze network links to determine critical nodes for all traffic.

Lastly, Patent Number WO 01/84877 to Jensen et al. discloses communications networks that is a partially interconnected topological network comprising at least six topological nodes. However, the Jensen et al. WO 01/84877 patent does not identify all of the network paths available for application traffic to reach end-customers through the static analysis of network configuration.

While the above-described devices fulfill their respective, particular objectives and requirements, the aforementioned patents do not describe a system and method for network service path analysis that identifies all of the network paths available for application traffic to reach end-customers through the static analysis of network configuration.

Therefore, a need exists for a new and improved system and method for network service path analysis that identifies all of the network paths available for application traffic to reach end-customers through the static analysis of network configuration. In this regard, the present invention substantially fulfills this need. In this respect, the system and method for network service path analysis according to the present invention substantially departs from the conventional concepts and designs of the prior art, and in doing so provides an apparatus primarily developed for the purpose of identifying all of the network paths available for application traffic to reach end-customers through the static analysis of network configuration, which is able to be applied to even the largest networks with potentially highly complicated rule sets.

### SUMMARY OF THE INVENTION

The present invention provides an improved system and method for network service path analysis and overcomes the above-mentioned disadvantages and drawbacks of the prior art. Specifically, while the present invention reflects the underlying principles of the reachability analysis presented in Xie, et. al. it relies on a significantly more scalable algorithm for determining reachability.

It will be noted that the computation of the transitive closure of a graph (Warshall's algorithm) has a time-complexity of O(n³), where n is the number of vertices in the graph, which is equal to the number of nodes in the network. The Xie, et. al. extension to Warshall's algorithm replaces the Boolean AND and OR operators in the dot product used in Warshall's matrix multiplication with Intersection and Union operators on the sets of permitted packets. Note that best known algorithm (Edelsbrunner and Maurer) for computing the intersection of permitted packet sets, represented as d-dimensional hyper-rectangles, itself has a time complexity of O(s log s) where s is the number of sets. If we assume that the rules and routing protocols found in the configuration of network devices result in the creation of R hyper-rectangles to represent the permitted packet flows, then the worst-case number of such sets is 2^{R}. Thus the time complexity of the Xie algorithm is O(2^{R}n³). The present invention utilizes data structures and algorithms that separates the computation of the intersection of permitted packet flows from the execution of Warshall's algorithm, and moreover represents the impact of packet filters and routing protocols in such a way as to minimize the size of the sets that need to be intersected.

As such, the general purpose of the present invention, which will be described subsequently in greater detail, is to provide an improved system and method for network service path analysis that has all the advantages of the prior art mentioned above. The present invention possesses many novel features that result in a system and method for network service path analysis which is not anticipated, rendered obvious, suggested, or even implied by the prior art, either alone or in any combination.

To attain this, the present invention essentially comprises a processor, memory connected to the processor, and a network service path analysis program loaded into memory and operable by the processor, wherein the network service path analysis program directs the processor to perform the steps of: (a) obtaining a list of device interface-to-interface relationships for a computer network; (b) obtaining a set of access control lists and rule sets from devices for the computer network; (c) creating a Layer 3 topology model from the device interface-to-interface relationships and association of packet filters on interfaces that defines each interface's packet filter configuration, each interface having an inbound and an outbound direction; (d) defining a set of vertices for each Layer 3 device; (e) defining a set of vertices for each endpoint subnet in the computer network; (f) defining a vertex representing the public Internet; (g) creating a directed graph comprising nodes for each device that routes traffic and/or performs packet filtering and for each subnet that contains host computers that are either providers or consumers of services where deliverability is to be analyzed, wherein the directed graph also comprises edges for each Layer 3 link between each device that routes traffic and the subnets that contain host computers that are either providers or consumers of services where deliverability is to be analyzed; (h) defining two sets of hyper-rectangles for each interface, one for the inbound and one for the outbound direction, representing sets of packets the interface's packet filter configuration will either permit or deny across the interface; (i) defining a set of hyper-rectangles for each interface representing sets of packets for which the routing configuration of the network permits outbound delivery; (j) intersecting the hyper-rectangles defined for all interfaces by steps (h) and (i) to decompose the IP packet space into all hyper-rectangles that may result from the intersection of the hyper-rectangles defined for all interfaces by steps (h) and (i); (k) representing the decomposition of a d-dimensional space as a set of hyper-rectangles and a directed acyclic graph describing their subset relations; (l) representing all subsets of a hyper-rectangle in the decomposition of step (k) by means of a subset mask; (m) representing the disposition, permit or deny, of sets of packets across an interface as rule masks encoding permit or deny values for each hyper-rectangle in the decomposition of step (k); (n) calculating rules masks from hyper-rectangles define in (h) and (i) and their associated subset masks; (o) computing a rule mask for each edge of the directed graph by performing Boolean operations on the rule masks defined by (m) by matching the inbound set for the leading vertex of the edge with the outbound sets computed for the trailing vertex of the edge; (p) annotating each edge of the directed graph of step (g) with rule masks representing the deliverability of packets across the edge; (q) determining the deliverability of packets by computing the transitive closure of the directed graph of step (p) where the Boolean operators of Warshall's algorithm are applied to the arrays of Boolean values annotated at each edge; (r) retrieving reachability for specific packet flows by means of a matrix of rule masks referencing the primary decomposition of the IP packet space; (s) retrieving path information for specific packet flows by means of a directed graph annotated with rule masks and a reachability matrix of rule masks referencing the primary decomposition of the IP packet space; (t) retrieving the specific network device configuration elements that determined the deliverability or non-deliverability of specific packet flows by means of a directed graph annotated with rule masks and a reachability matrix of rule masks referencing the primary decomposition of the IP packet space; and (u) storing the result of step (t) in the memory.

There has thus been outlined, rather broadly, the more important features of the invention in order that the detailed description thereof that follows may be better understood and in order that the present contribution to the art may be better appreciated.
The invention may also include a method of creating of a directed graph of an IP network topology so that each edge may be queried for the transmissibility of a selected subset of the IP packet space comprising the steps of: creating a rule mask for each edge of the directed graph encoding a Boolean value for each partition of a decomposition of the IP packet space indicating the transmissibility of all packets contained in the partition and annotating the edges of the directed graph with said the rule mask. In one variation, this method may also further include the steps of parsing a network device configuration for each network device in an IP network; identifying inbound and outbound interfaces of the network devices; analyzing network routing protocol and interface packet filter configuration; and decomposing the IP packet space into partitions. In a second variation, this method may also comprise the steps of selecting a particular packet, locating that packet within an IP space partition, using the Boolean values to determine the transmissibility of the packet across a predetermined edge of the directed graph, and computing the transitive closure of said annotated directed graph.

The invention may also include a method of identifying the paths through an IP network of network devices comprising network address spaces over which selected packet sets may be delivered from a specified subnet to a specified subnet comprising the steps of: (a) creating a directed graph of the network topology comprising vertices, in which each directed graph vertex is selected from the set comprising a network device, an endpoint subnet, and a range of endpoint IP addresses, and in which each directed graph edge represents a nearest neighbor relation between a first device and a neighbor selected from the set of a second device, a subnet, and a range of endpoint IP addresses; (b) annotating each directed graph edge with a description of subsets of the IP address space that are configured to be transmitted across the edge; (c) creating a reachability matrix identifying for each vertex pair the subsets of the IP address space that are deliverable from one vertex to the other; (d) identifying edges of the graph that will permit the transmission of the packet set; (e) defining a head vertex and a tail vertex for a user-selected packet set transmission from a user-selected source device to a user-selected destination device; and (f) determining a path for the user-selected packet set transmission from the user-selected source device to the user-selected destination device. This method may further include the step of analyzing packet filter configurations of network device interfaces to determine elements in a configuration of devices in an IP network that cause a selected path through the network to be permitted or that may cause a selected path to be denied. Step (b) of annotating may further comprise the steps of: defining a leading vertex and a trailing vertex for a selected path to an edge; computing a first rule mask for packet filters on an inbound interface associated with said leading vertex of said edge, a second rule mask for packet filters configured on an outbound interface associated with said trailing vertex of said edge, and a third rule mask for routing configuration configured on an outbound interface; and then performing Boolean operations on the rule masks, namely performing a Boolean AND operation on the three rule masks, to determine a set of transmission rules.

The invention may also include a method for creating a reachability matrix from the annotated directed graph derived from the preceding method including the steps of (a) decomposing the network into partitions of an IP packet space; and (b) generating a rule mask encoding a Boolean value for each partition in the decomposition, a state of the Boolean value indicating whether the packet set is deliverable from the source to the destination. The decomposition of IP space may further comprise subsets of IP space wherein multiple packets will be delivered from any specified source to any specified destination across identical transmission paths. The decomposition subsets may comprise: (a) a first set of rule boxes comprising packet filter rules configured on network device interfaces and routing configuration rules; (b) a second set of rule boxes representing all possible intersections of subsets of packet filter rules and routing configuration rules; and (c) a directed acyclic graph representing the superset-subset relations between the first set of rule boxes and the second set of rule boxes. The first and second set of rule boxes may be used to compute rule masks associated with packet filters configured on the inbound and outbound interfaces of a network device. A subset mask for the first and second sets of rule boxes in the decomposition of the space may be computed as a by-product of a topological sort of the directed acyclic graph of decomposition subset relations.

The invention may also include a method of annotating edges of a directed graph of an IP network topology for the transmission of packets and sets of packets via routing rules and packet filters, wherein the network comprises network devices and interfaces between the network devices, so that each edge of the directed graph may be queried for the transmissibility of a selected subset of the IP packet space including the steps of: (a) decomposing the IP packet space into partitions, each partition having the property that the intersection of any collection of packet sets defined by packet filters and routing rules in configurations of the network devices will be expressible as the union of partitions in the decomposition; (b) defining a rule mask for each edge; and (c) encoding a Boolean value for each the partition indicating the transmissibility across the edge of all packets contained in the partition.

The present invention may be a module that can use other programs for input as well as supply other programs with the connectivity data for further processing. For example, a payroll system is deployed from the data-center network and must be available to Finance and Human Resources. In this simple case, if the IP addresses and ports of the payroll system servers are known and the IP addresses or sub-networks of Finance and Human Resources are known, then by using the Network Path Database created by the present invention, the explicit path that payroll system traffic can take to Human Resources and Finance can be computed by querying the a network path database

### BRIEF DESCRIPTION OF THE DRAWINGS

These together with other objects of the invention, along with the various features of novelty that characterize the invention, are pointed out with particularity in the claims annexed to and forming a part of this disclosure. For a better understanding of the invention, its operating advantages, and the specific objects attained by its uses, reference should be had to the accompanying drawings and descriptive matter in which there is illustrated current embodiments of the invention. Such description makes reference to the annexed drawings wherein:

FIG. 1 is a graphical view of a prior art representation of a computer network;

FIG. 2 is a directed graph view of a prior art representation of a computer network;

FIG. 3 is a flow diagram view of the Layer 3 connectivity determination program of the present invention;

FIG. 4 is a directed graph view of a computer network constructed in accordance with the principles of the present invention;

FIG. 5 is a flow diagram view of the incorporate routing architecture and policy program of the present invention;

FIG. 6 is a flow diagram view of the determined the paths that the deliverable packets may traverse program of the present invention;

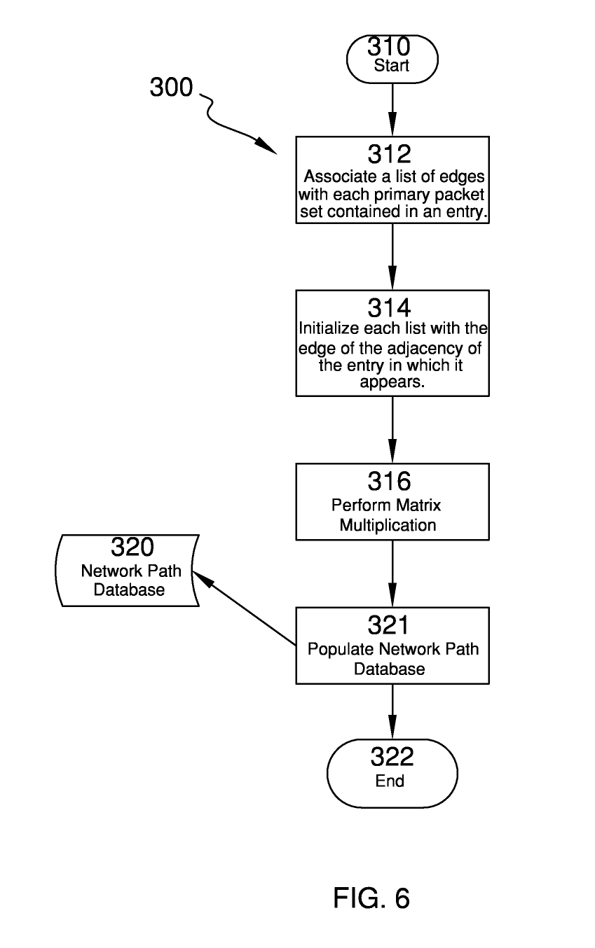

FIG. 7 is a schematic view of the service path analysis engine constructed in accordance with the principles of the present invention; and

FIG. 8 is a flowchart illustrating the steps of the present invention.

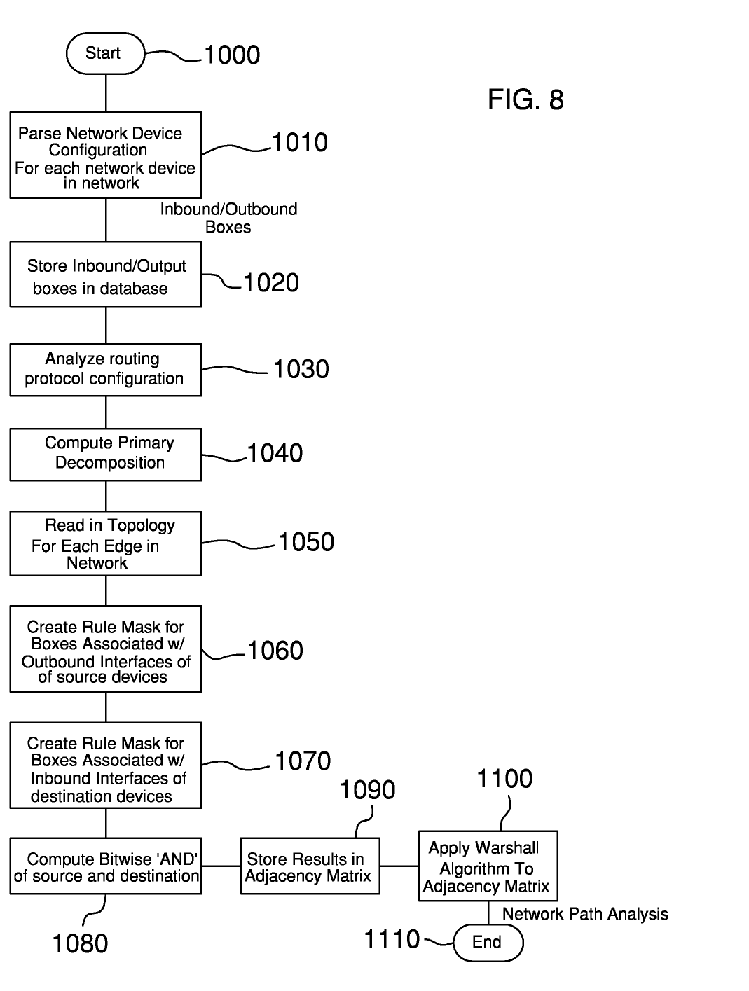

The same reference numerals refer to the same parts throughout the various figures.

### DESCRIPTION OF THE CURRENT EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and an “application,” a “computer program,” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention.

In order to accomplish the analysis of reachability and the handling of reachability and path queries, the following software components are utilized.
1. The Layer 3 Topology Graph represents the discovered or provided graph of Layer 3 network connectivity, in which vertices represent the network devices (routers and firewalls) and the edges represent IP adjacencies between the devices. The graph is a directed graph, i.e., for every pair of devices, U and V, that are adjacent in the layer 3 topology, there are two edges, one from U to V and one from V to U.
2. The Configuration Parser examines configuration files retrieved from the network devices and parses the routing configuration and packet filter rules (Examples: ACLs and firewall rules) to produce the Rule Boxes described below.
3. The Reachability Analyzer creates a Reachability Matrix providing for each pair of vertices in the Topology Graph the Packet Flow Mask describing which packets are deliverable and which are undeliverable between the vertices.
4. The Query Processor utilizes the Layer 3 Topology Graph and the Reachability Matrix to answer 3 Types of queries:
   A. Is a specified Packet Flow deliverable from a specified source vertex to a specified destination vertex in the graph?
   B. For a specified source vertex and destination vertex what are the possible paths through the graph over which a specified Packet Flow may be delivered?
   C. For a specified path in the graph, what elements, if any, in the packet filter configuration of the devices in the path determine whether a specified Packet Flow is deliverable or undeliverable?

The following data structures are created and utilized by the software components.
1. The Packet Space Configuration defines the dimensions used to represent Packet Flows and Packet Filters in all other components of the software. Following standard practice we represent Packet Flows as n-dimensional hyper-rectangles (or “boxes”) where each dimension represents a field in the IP Header. At a minimum these dimensions are:
   Source Address—32 bits: 000.000.000.000 thru 255.255.255.255
   Source Port=16 bits: 0 thru 65535
   Destination Address—32 bits: 000.000.000.000 thru 255.255.255.255
   Destination Protocol—8 bits: 0 thru 256
   Additional fields may be included to represent other vendor-specific determinants of packet forwarding, e.g. Cisco's “established” flag.
2. Rule Boxes are representation of permitted or denied sets of packets as determined by the configuration of device interfaces. There are two kinds of Rules Boxes, Routing Boxes and Packet Filter Boxes:
   A. Routing Boxes are determined from by the Configuration Parser for each outbound device interface according to the procedure described by Xie, et al. A routing box provides a minimum and maximum value for the Destination IP Address, but in all other dimensions extends over the entire range of the dimension. We associate with each device interface a Routing Box for each destination subnet whose packets may be routed through the interface.
   B. Packet Filter Boxes are determined from the Firewall Rules and Access Control Lists configured on the interfaces of routers in the network. Each rule in the configuration is parsed in order, a box describing the impact of the rule is created and stored with an sequence number indicating its position in the list of configured rules and an action flag, either “permit” or “deny”.
3. The Primary Decomposition contains all distinct Rule Boxes discovered by the Configuration Parser as well as all of the possible intersections of the Rule Boxes with each other. Additionally, for each Box in the primary decomposition, we maintain links (subset links) to all other boxes that are contained by the box. To compute the intersections, we perform a plane sweep through the set of primary rectangles on the nth dimension. A multi-layered data structure (as described by Edelsbrunner and Maurer), comprising nested segment trees and range trees is maintained for identifying intersecting pairs of rectangles. Since the plane sweep will identify intersections in the nth dimension the Edelsbrunner tree need only accommodate the d-1 dimension projections each rectangle. As each of the primary rectangles enters the sweep window it is intersected with those in the current window. The intersecting pairs are updated with pointers to their intersections to maintain the subset graph. The discovered intersections are checked against each other for superset-subset relations and their subset links are updated. All intersections are added to the Edelsbrunner tree so that their intersection with subsequent arrivals in the window may be identified. As each rectangle leaves the sweep window it is deleted from the tree and written to the database.
The subset links on the Boxes in the Primary Decomposition comprise a Directed Acyclic Graph (DAG). We perform a topological sort on the subset DAG and assign to each Box in the set an index number determined by the topological sort. Then for any two rectangles B₁ and B₂, if B₂ is a subset of B₁, then index (B₂)<index (B₁).
The Primary Decomposition defines a partition of the entire IP Packet space into distinct subsets. For a Primary Decomposition consisting of N boxes, B₁, . . . , B_{N}, where Sᵢ represents the union of all proper subsets of Bᵢ, then the set, K, of N polytopes, K₁, . . . , K_{N}, with Kᵢ=Bᵢ−Sᵢ, is that partition. Every point, p, in the IP Packet space may be located uniquely in one element of K, specifically Kⱼ, where j is the smallest index for which Bⱼ contains p. For simplicity, we refer to a point “belonging a box” when we mean that the point is contained in the polytope from K associated with the box.
4. Rule Masks are bit sets that encode the disposition of packets across a device interface in terms of the Primary Decomposition. A Rule Mask contains one bit, set to either “true” or “false” for each Box in the Primary Decomposition. The value of the bit at index k indicates whether IP packets belonging to the Box with index k in the Primary Decomposition are permitted (“true”) or denied (“false”). Rule Masks are created first for device interfaces. Then for each directed edge of the Layer 3 graph we associate a Rule Mask created by performing a bitwise AND of the Rule Masks associated with the interfaces on the source and destination vertices of the edge. The Rule Masks associated with the edges of the graph are used to populate the initial adjacency matrix of the graph from which a reachability matrix (the transitive closure of the graph) will be computed.
The Rule Masks for a device interface are computed as follows. We first create one Rule Mask for the “inbound” direction, examining each Packet Filter Box we have identified as “inbound” for the interface, from the bottom up, i.e., beginning with the last rule and moving to the first. If the action specified by the rule is “permit” we set the bit at the index of that rule's Packet Filter Box and the bits of all of its subsets to “true”. If the action is “deny” we set those bits to “false”. If there are no Packet Filter rules configured on the interface, we set all bits to “true”.
For the outbound direction we create a Rule Mask in the same way for the “outbound” rules of the interface. Moreover, we create an interim Routing Rule Mask, examining the Routing Boxes for each setting the bit at the index of the Routing Box and to each of its subsets to “true”. We combine the Packet Filter Rule Mask for the outbound interface with the Routing Rule Mask by means of a bitwise AND to arrive at the final outbound Rule Mask. For each edge the associated Rule Mask will then be the combination of the outbound Mask of the source vertex with the inbound Mask of the destination vertex.
5. Subset Masks encode the subsets of each Box in the Primary Decomposition. For a box, Bⱼ, the jth bit is set to “true” as are the bits at the indices of all subsets of Bⱼ. Subset Masks may be created during the topological sort of the Boxes in the Primary Decomposition. As box Bⱼ is visited, initialize all Subset Mask bits to “false”, set the bit at j to “true” and perform a Boolean OR with the Subset Mask of each of Bⱼ's children.
Subset Masks are used in creating the Rule Masks for each interface. In the bottom-up handling of Packet Filter Boxes, if the Packet Filter Box is marked “permit”, perform a Boolean OR of the Rule Mask with the Subset Mask associated with the Packet Filter Box. If the Packet Filter Box is marked “deny”, perform a Boolean AND of the Rule Mask with the negation of the Subset Mask associated with the Packet Filter Box. When all Packet Filter Boxes are reflected in the Rule Mask a separate Rule Mask may be created by performing a Boolean OR on Subset Masks associated with all of the Routing Boxes. Then by performing a Boolean AND of the Rule Mask from the Packet Filter Boxes with the Rule Mask from the Routing Boxes yields the Rule Mask associated with that interface-direction pair.

The Query Processor handles each type of query as follows:
1. Query: Is a specified Packet Flow deliverable from a specified source vertex to a specified destination vertex in the graph?
For deliverability queries, the input consists of a Source and Destination vertex, and a specification of a set of packets whose deliverability is to be tested. The specification may be in the form of a range of values for each field of the IP header that is specified in the Packet Space Configuration, or as a rule in a proprietary packet filter syntax known to the Configuration Parser. In either case the Query Processor creates a Rule Box to represent the packet set and decomposes this Rule Box into components, each of which lie within one partition of the primary decomposition. This is accomplished by identifying all boxes in the primary decomposition that intersect it, then computing the intersection of each in reverse subset order: from the smallest to the largest. After each intersection is computed the index number of the intersecting box and its deliverability value is stored with the result and the result is subtracted from the target Rule Box. The remainder then becomes the target for the next intersection. The Query Engine returns a list of all resultant boxes.
2. Query: Is a specified Packet Flow deliverable from a specified source vertex to a specified destination vertex in the graph?
A path query takes input identical to that of a deliverability query. The deliverable portions of the Target are determined as in the deliverability query. For each deliverable component of the Target and the index of the Rule Box in the Primary Decomposition whose intersection produced the result is tested first against the annotated directed graph. If the Rule Mask on the edge from the Source Vertex to the Destination Vertex has the value “true” at this index, the this portion of the target is transmissible across the edge. The Reachability Matrix is then queried twice, once for the deliverability of this portion from the Source Vertex to the vertex at the tail of the edge, and once for the deliverability of this portion from the head of the edge to the Destination Vertex. If the value at the index in both Rule Masks is “true” the edge is included in the edge set of the returned deliverable potion.
3. Query: For a specified path in the graph, what elements in the packet filter configuration of the devices in the path determine whether a specified Packet Flow is deliverable or undeliverable?
Here the input consists of a target packet set as in 1 and 2 above with a list of edges representing a path from a source to a destination vertex and a flag indicating whether the query is to identify a permitting or denying configuration element.
If the query is a “permitting” query, the deliverability of the packet set from the initial vertex to the final vertex is determined as in 1 above. If it is deliverable, the edge list for each component in the decomposition of the target to ensure that each edge of the input path is present. If all components are found to be undeliverable, or if an edge in the input path is not present in any component's edge list, an error is returned. Otherwise the edges of the input path are checked in order from Source to Destination vertex, and, for each edge, the sequence of Rule Boxes analyzed for the outbound interface of tail vertex and for the inbound interface of the head vertex are examined. The Rule Boxes are traversed from top to bottom until identifying one that contains the target. The sequence number of the containing box is captured along with an identifier of the device and the interface. When all edges have been examined the list of permitting device-interface-sequence numbers is returned.
If the query is a “denying” query, again the reachability and edge list is identified for each component of the target. If all components are deliverable and all edges of the input path are present in the edges list, an error is returned. For any component that is undeliverable or for which an edge in the edge list is missing from its edge list, the edges of the input path are tested as for the “permitting” query, but the sequence of Rule Boxes at each interface are examined for the first containing box. The first device-interface-sequence number found to deny transmission of the component is captured and the search is ended.

Referring now to the drawings, a current embodiment of the system for network service path analysis of the present invention is shown and generally designated by the reference numeral 700.

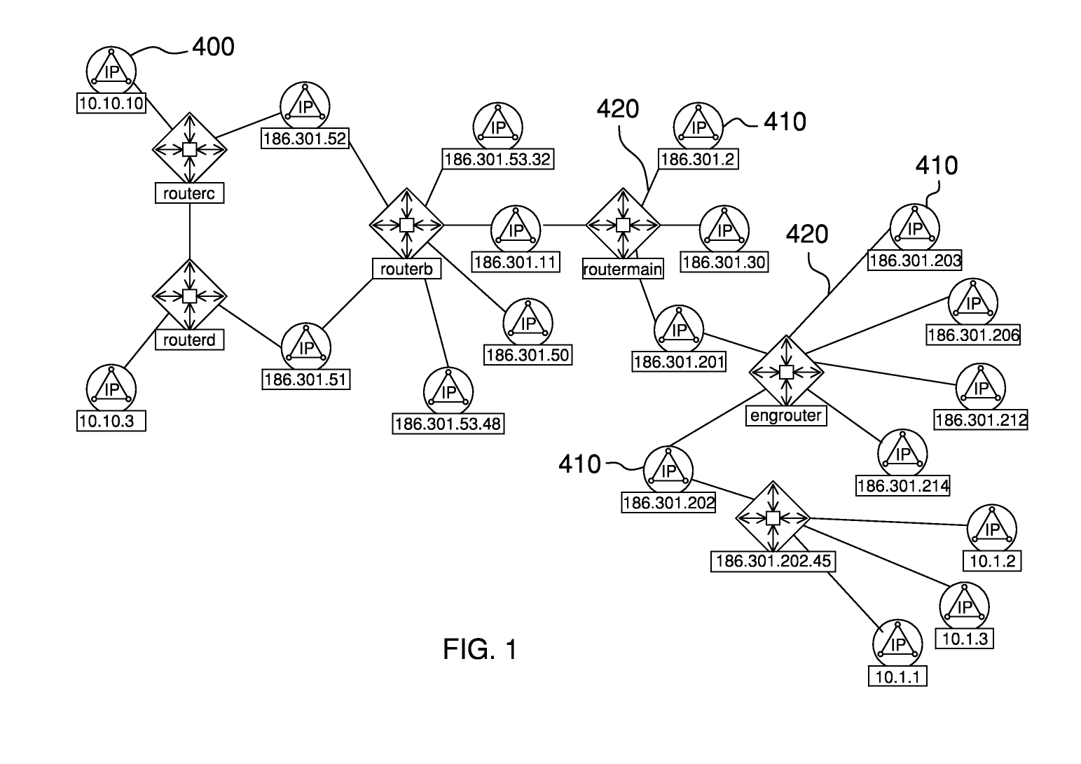

FIG. 1 illustrates a standard graph of nodes representation of a computer network 400. The vertices are portrayed by icons denoting nodes 410, representing various types of network devices, and the edges as lines 420 connecting the icons.

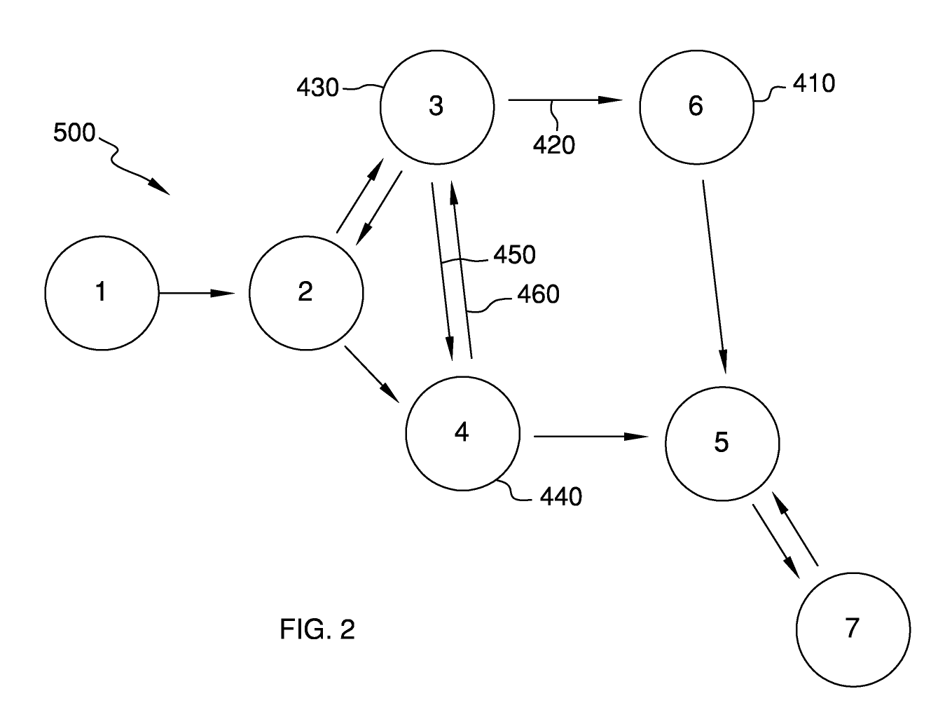

FIG. 2 illustrates a prior art directed graph 500. The edges denoted as lines 420 connecting the nodes 410 each have an origin and a destination node 410. The deliverability of packets in both directions between two nodes 410 is represented by two separate edges. For example, deliverability of packets in both directions between node “3” 430 and node “4” 440 is denoted by two lines 450 and 460. Line 450 goes from node “3” 430 to node “4” 440, and line 460 goes from node “4” 440 to node “3” 430.

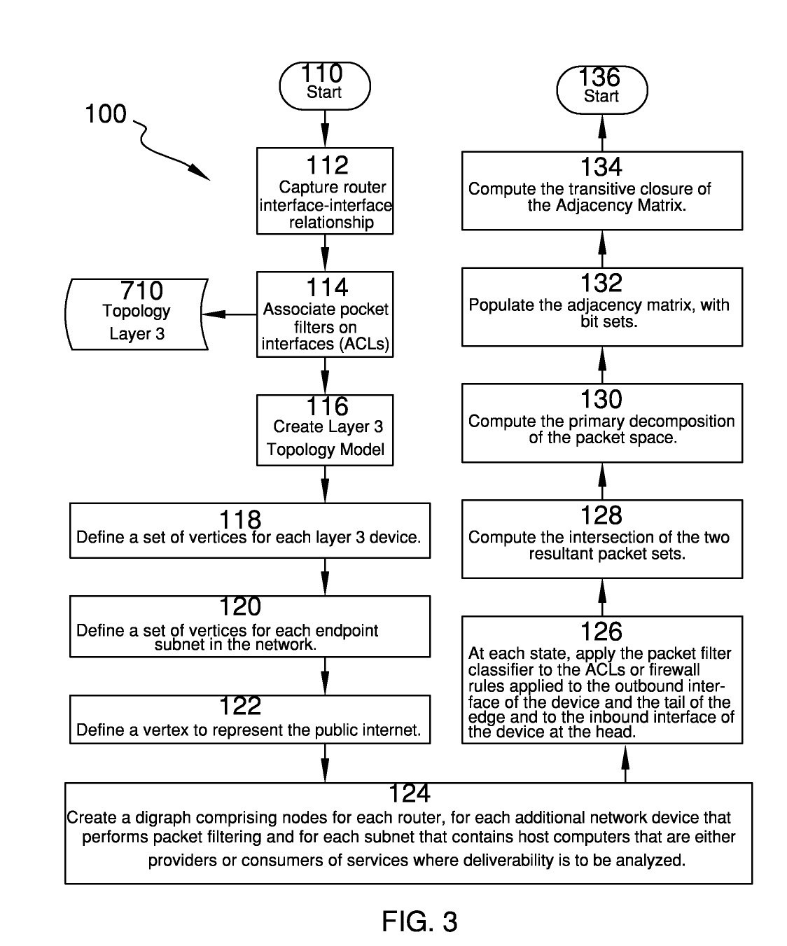

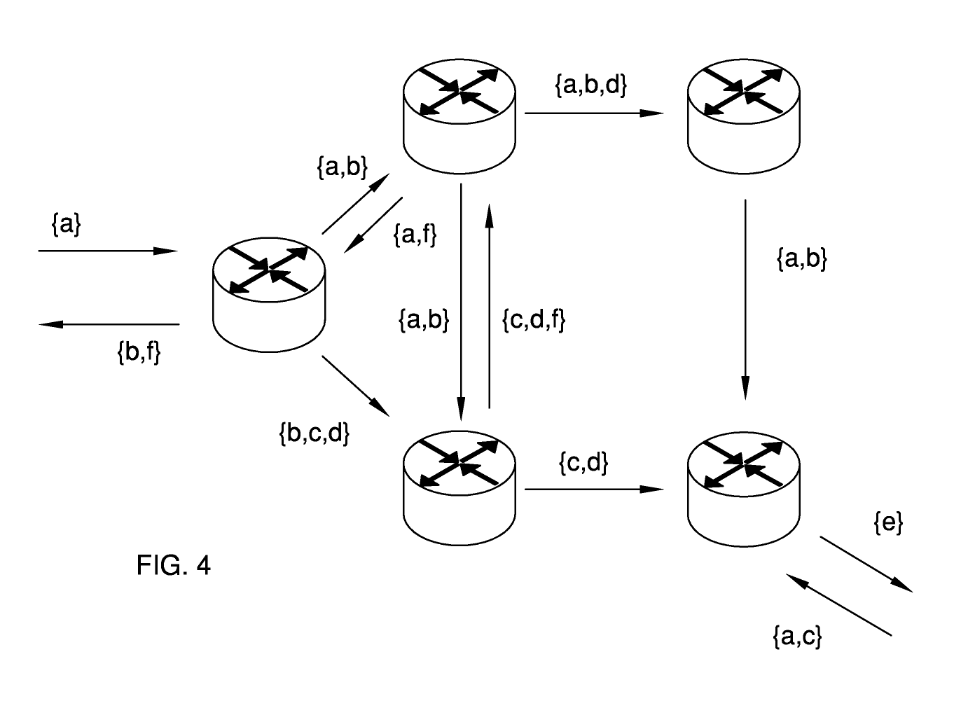

FIG. 3 illustrates improved Layer 3 connectivity determination program 100 of the present invention. FIG. 4 illustrates a directed graph 600 of the present invention. The first step in building the relationship model is capturing Layer 3 topology 710 (116). Layer 3 topology 710 consists of the following:
Router interface-to-interface relationship (112)
Association of packet filter on interfaces (ACLs) (114)

Utilizing the Layer 3 Topology model 710 created in step (116), one defines a set of vertices for each Layer 3 device (118), each endpoint subnet in the network (120), and a vertex to represent the public Internet (122). For each edge 420, one should be provided identifiers allowing retrieval of the modeled device at each vertex as well as the identifiers of the specific interfaces over which packets are carried between adjacent elements.

From the retrieved Layer 3 topology 710, a directed graph 600 is created (124) comprising nodes 410 of the following types:
1. A node 410 for each router and for each additional network device that performs packet filtering (e.g. firewalls).
2. A node 410 for each subnet that contains host computers that are either providers or consumers of the services whose deliverability is to be analyzed. Typically these will be exterior to the network; i.e. they will be linked to router interfaces that are linked to no other router. However, there may be hosts in the interior of the network—these may be identifiable either by the topology discovery mechanisms or by querying the user.

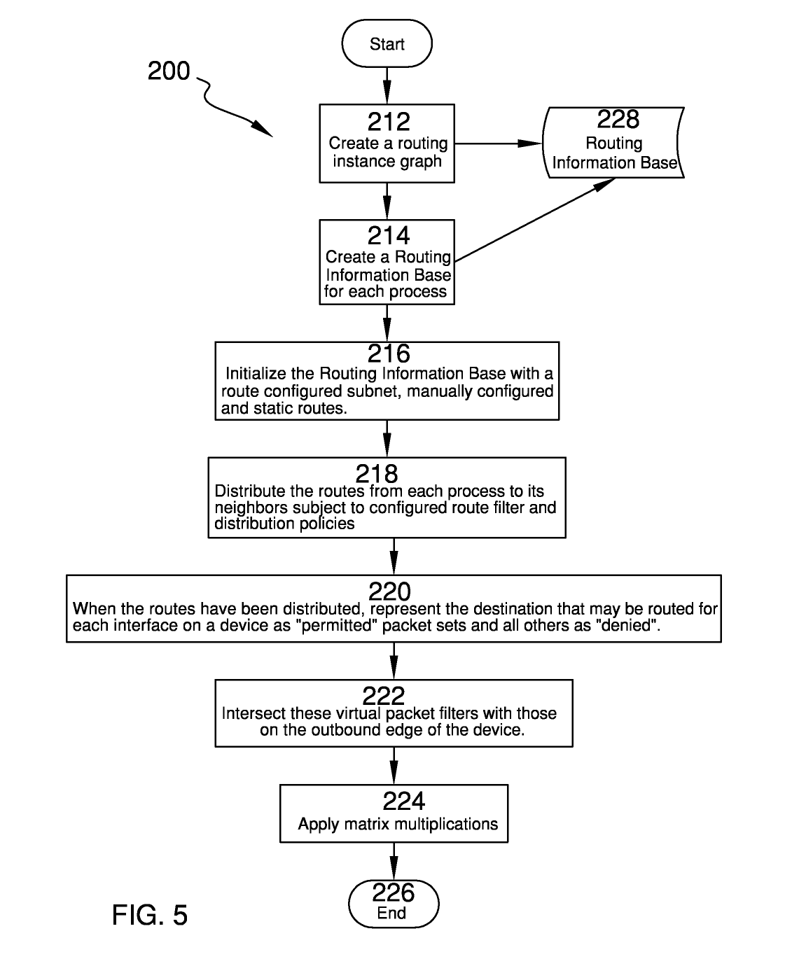

FIG. 5 illustrates an improved program 200 of the present invention to incorporate routing architecture and policy into the present invention pursuant to the method proposed by Xie, et al. by modeling their impacts as packet filters. To utilize this method in the present invention, first a routing instance graph is created (212). This is a graph whose vertices are routing processes on network devices 410 and whose edges 420 represent the adjacency of routing process: routing processes are adjacent if they are configure on IP-adjacent interfaces and employ the same routing algorithm. A Routing Information Base (228) is created for each process (214) and is initialized with a route for each interface to its configured subnet, as well as any manually configured and static routes (216). The routes are then distributed from each process to its neighbor subject to configured route filters and distribution policies (218). When routes have been thoroughly distributed, the destinations that may be routed for each interface on a device 410 are represented as “permitted” packet sets and all others as “denied” (220). These virtual packet filters may then be intersected with those on the outbound edge of the device 410 (222). Subsequent application of the matrix multiplications (224) will then reflect deliverability of packets only over paths permitted by the routing configuration.

From this matrix, the current invention may populate the Network Path Database 320 (318), capturing the set of packets deliverable between any pair of IP addresses in the network. Given a source and destination, one can query the Network Path Database for the packet flows that are deliverable, and retrieve the list of Router-to-Route links that may be traversed in their delivery.

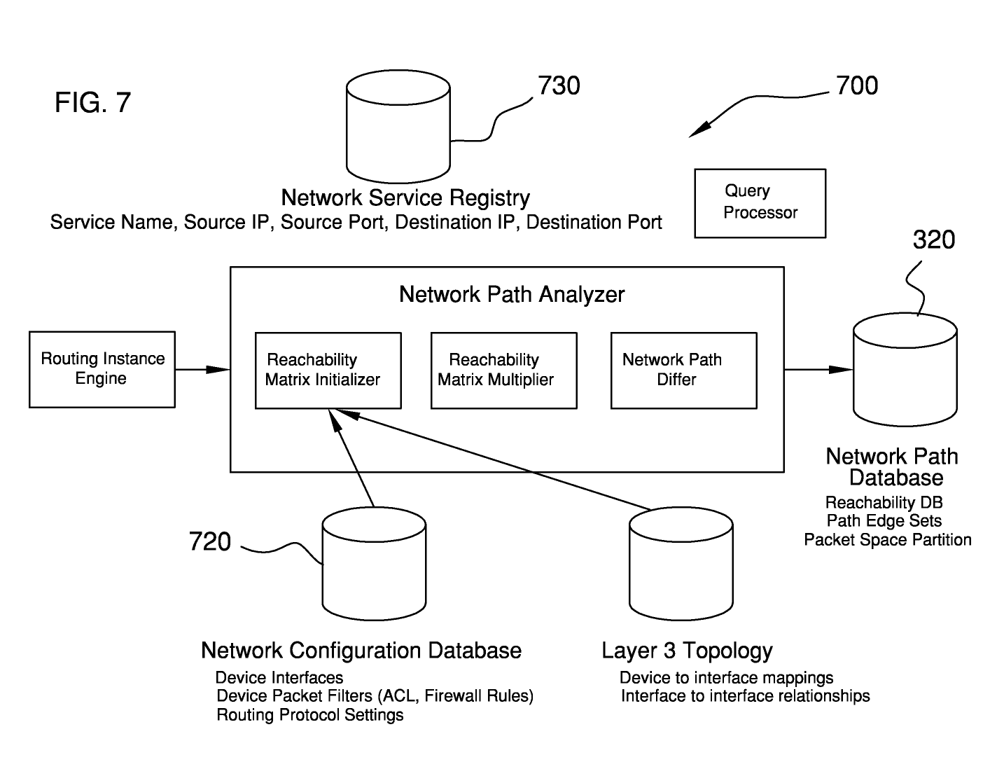

FIG. 7 illustrates a service path analysis engine 700 of the present invention. By representing the deliverability and the available paths in terms of the IP header fields, the present invention has extended the Layer 3 topology to incorporate Layer 4 (protocol UDP or TCP) and Layer 7 (port number). By mapping named services to IP addresses and port numbers, the present invention can bind network path information to the application. This binding allows for the computation of the explicit paths a given application's traffic can traverse using the Network Path Database 320. This set of explicit paths defines the logical boundary of a network service and explicitly partitions the network into the sub-network, which delivers the Application to a given set of customers. Once the network relationships are captured and analyzed, a broad set of applications become possible, by leveraging the Service Path Analysis Engine 700, Layer 3 Topology 710, and the network configuration database 720.

Turning now to FIG; 8, a flowchart overview of the method of the present invention is presented. The process begins (step 1000) by parsing the network device configuration for each network device in the network (step 1010). Inbound/Outbound boxes are identified and stored in a database (step 1020). After analyzing the routing protocol configuration (step 1030), the primary decomposition is computed (step 1040). Step 1040 limits the amount of ongoing processing throughout the rest of the approach. Subsequently, the topology for each edge in the network is read (step 1050), and rule masks for the boxes associated with outbound interfaces of source devices and the inbound interfaces of destination devices are created (steps 1060 and 1070). Once the bitwise “AND” of the source and destination is computed (step 1080), the results are stored in an adjacency matrix (step 1090). Finally, the Warshall algorithm is applied to the adjacency matrix to create the network path analysis (step 1100), and the process ends (step 1110).

The Rule Boxes, Primary Decomposition and Reachability Matrix all are created within a specified Area of Interest. In the above description we have assumed the Area of Interest to be the entire IP Packet space. But to improve performance or to minimize storage requirements, the Area of Interest may be specified as a specific subset of the packet space. The Area of Interest is itself a box with minimum and maximum values set for each of the n dimensions. For a given Area of Interest, the Rule Boxes and Routing Boxes on each interface are intersected with the Area of Interest and those results are used to compute the Primary Decomposition. In this way, a complete Reachability Analysis can be performed by partitioning the IP Packet space into distinct Areas of Interest, e.g. along subset boundaries, and then delegating the analysis of each to a separate processor. Or, specific reachability queries concerning services of especial interest may be processed by defining the Area of Interest in terms of the Destination Subnet/Destination Port associated with the service.

In use, it can now be understood that there are a number of ways to use the present invention. The present invention may use its results itself. The present invention may also function as a callable module to another program. The program calling the present invention may create a query and utilize the results, or it may simply call the present invention for the results of the previous query.

Given only the Network Path Database 320 the following general questions can be answered:
Given a set of source [IP address, Port, Protocol] triples what set of IP addresses are reachable?
Given a set of source [IP address, Port, Protocol] triples and a set of destination IP addresses, what is the set of network paths?

With the Service Path DB and the Network Path DB there are general set of service questions possible now possible given the SPA approach:
Who can get this service?
Who can't get this service?
From a given client, which services can I get?
For a given service what devices (and configurations) provide this service?
What service is impacted with this change?

Service Diagnostics and Trouble-shooting: A user is unexpectedly unable to access a certain service. What is the source of the problem? Is the problem in the configuration of the devices or are devices or cabling disabled? We can test the packet header IP address of the host and the IP address and port of the server to determine if the network is, in fact, configured to deliver packets between them. If not, we can successively test the links from the host subnet to network nodes one hop away, then two hops, etc. until identifying links, which do not permit these packets to be delivered. This solves for the classic question: “Is it the application or the network?”

Service Change Report: The difference between two reachability matrices identify what packets are deliverable under one configuration but not under the other.

On a nightly process a Service Change Report could be generated to show the difference in service paths from one day to the next. This allows organization to determine the net effect of the change at a service level on their network. Instead of getting network level changes, network operations teams would receive a summary of services that were affected with service path detail and the specific configuration that affected the service. This service change report could be run a priori a change to predict the impact of configuration change on services delivered by the network, enabling true change impact prediction.

Network¹ Service Compliance: We can now create rules for network-wide reachability compliance, specifying which service traffic must be or must not be deliverable and testing proposed changes a priori against network policies expressed through service path rules. This represents a significant improvement over current device-specific compliance and allows for network compliance rules sets to be evaluated for consistency. 1 Current Device Authority is only able to perform network device compliance. Network rules are specified at the device level.

Network Operation Analytics: Adding the network service registry 730 and Network Path Database 320 adds the “relationship” dimension to the network configuration database 720. By adding network and service path context, the following questions can be answered by forming queries to the network path database joining the results external asset information about the network devices that comprise the network:
What is the total amount of hardware used to deliver a service?
What are the hardware maintenance costs of a service?
Is this service over or under provisioned?

While a current embodiment of the system and method for network service path analysis has been described in detail, it should be apparent that modifications and variations thereto are possible, all of which fall within the true spirit and scope of the invention. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. For example, a wide range of information storage and retrieval devices, applications, and formats may be used instead of the databases described.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1. A method of creating a directed graph comprising nodes and edges of an IP network topology so that each edge may be queried for the transmissibility of a selected subset of the IP packet space, comprising:
creating a rule mask for each edge of a directed graph encoding a Boolean value for each partition of a decomposition of the IP packet space indicating the transmissibility across that edge of all packets contained in the partition; and
annotating the edges of the directed graph with said rule mask.

2. The method of claim 1 further comprising:
parsing a network device configuration for each network device in an IP network;
identifying inbound and outbound interfaces of said network devices;
analyzing network routing protocol configuration and interface packet filter configuration;
representing said network as a directed graph; and
decomposing the IP packet space into partitions.

3. The method of claim 1 further comprising:
selecting a set of packets;
locating said packet set within an IP space partition;
using said Boolean values to determine the transmissibility of said packet set across an edge of the directed graph.

4. A method of identifying the paths through an IP network over which selected packet sets may be delivered from a specified subnet to a specified subnet, comprising the steps of:
(a) creating a directed graph of the network topology comprising vertices, in which each directed graph vertex is selected from the set comprising a network device, an endpoint subnet, and a range of endpoint IP addresses, and in which each directed graph edge represents a nearest neighbor relation between a first device and a neighbor selected from the set comprising a second device, a subnet, and a range of endpoint IP addresses;
(b) annotating each directed graph edge with a description of subsets of the IP address space that are configured to be transmissible across the edge;
(c) creating a reachability matrix identifying for each vertex pair the subsets of the IP address space that are deliverable from one vertex to the other;
(d) identifying edges of the graph that will permit the transmission of the packet set;
(e) defining a head vertex and a tail vertex for a user-selected packet set transmission from a user-selected source device to a user-selected destination device; and
(f) determining a path for the user-selected packet set transmission from the user-selected source device to the user-selected destination device.

5. The method of claim 4 further comprising analyzing packet filter configurations of network device interfaces to determine elements in a configuration of devices in an IP network that cause a selected path through the network to be permitted.

6. The method of claim:4 further comprising analyzing packet filter configurations of network device interfaces to determine elements in a configuration of devices in an IP network that cause a selected path through the network to be denied.

7. A method for creating a reachability matrix from the annotated directed graph in claim 4, comprising the steps of:
(a) decomposing the network into partitions of an IP packet space;
(b) generating a rule mask encoding a Boolean value for each partition in the decomposition, the state of said Boolean value indicating whether the packet set is deliverable from the source to the destination; and
(c) computing the transitive closure of said annotated directed graph.

8. The method of claim 7 in which the decomposition of IP space further comprises subsets of IP space wherein multiple packets will be delivered from any specified source to any specified destination across identical transmission paths, wherein said decomposition subsets comprises:
(a) a first set of rule boxes comprising packet filter rules configured on network device interfaces and routing configuration rules;
(b) a second set of rule boxes representing all possible intersections of subsets of packet filter rules and routing configuration rules; and
(c) a directed acyclic graph representing the superset-subset relations between said first set of rule boxes and said second set of rule boxes.

9. The method of claim 8 wherein said first and said second set of rule boxes is used to compute rule masks associated with packet filters configured on the inbound and outbound interfaces of a network device.

10. The method of claim 9 wherein a subset mask for said first and second sets of rule boxes in the : decomposition of the space is computed as a by-product of a topological sort of the directed acyclic graph of decomposition subset relations.

11. The method of claim 5 wherein the step of annotating further comprises:
(a) defining a leading vertex and a trailing vertex for a selected path to an edge;
(b) computing a first rule mask for packet filters on an inbound interface associated with said leading vertex of said edge, a second rule mask for packet filters configured on an outbound interface associated with said trailing vertex of said edge, and a third rule mask for routing configuration configured on an outbound interface; and
(c) performing Boolean operations on said rule masks to determine a set of transmission rules.

12. A method of annotating edges of a directed graph of an IP network topology for the transmission of packets and sets of packets via routing rules and packet filters, wherein the network comprises network devices and interfaces between the network devices, so that each edge of the directed graph may be queried for the transmissibility of a selected subset of the IP packet space, comprising the steps of:
(a) decomposing the IP packet space into partitions, each partition having the property that the intersection of any collection of packet sets defined by packet filters and routing rules in configurations of the network devices will be expressible as the union of partitions in the decomposition;
(b) defining a rule mask for each edge; and
(c) encoding a Boolean value for each said partition indicating the transmissibility across the edge of all packets contained in the partition.

13. A method of network service path analysis comprising the steps of:
(a) obtaining a list of device interface-to-interface relationships for a computer network;
(b) obtaining a set of access control lists and rule sets from devices for the computer network;
(c) creating a Layer 3 topology model from the device interface-to-interface relationships and association of packet filters on interfaces that defines each interface's packet filter configuration, each interface having an inbound and an outbound direction;
(d) defining a set of vertices for each Layer 3 device;
(e) defining a set of vertices for each endpoint subnet in the computer network;
(f) defining a vertex representing the public Internet;
(g) creating a directed graph comprising nodes for each device that routes traffic and/or performs packet filtering and for each subnet that contains host computers that are either providers or consumers of services where deliverability is to be analyzed, wherein the directed graph also comprises edges for each Layer 3 link between each device that routes traffic and the subnets that contain host computers that are either providers or consumers of services where deliverability is to be analyzed;
(h) defining two set of hyper-rectangles for each interface, one for the inbound and one for the outbound direction, representing sets of packets the interface's packet filter configuration will either permit or deny across the interface;
(i) defining a set of hyper-rectangles for each interface representing sets of packets for which the routing configuration of the network permits outbound delivery;
(j) intersecting the hyper-rectangles defined for all interfaces by steps (h) and (i) to decompose the IP packet space into all hyper-rectangles that may result from the intersection of the hyper-rectangles defined for all interfaces by (h) and (i);
(k) representing the decomposition of a d-dimensional space as a set of hyper-rectangles and a directed acyclic graph describing their subset relations;
(l) representing all subsets of a hyper-rectangle in the decomposition of step (k) by means of a subset mask;
(m) representing the disposition, permit or deny, of sets of packets across an interface as rule masks encoding permit or deny values for each hyper-rectangle in the decomposition of step (k);
(n) calculating rules masks from hyper-rectangles defined in steps (h) and (i) and their associated subset masks;
(o) computing a rule mask for each edge of the directed graph of step (g) by performing Boolean operations on the rule masks defined by (m) by matching the inbound set for the leading vertex of the edge with the outbound sets computed for the trailing vertex of the edge;
(p) annotating each edge of the directed graph of step (g) with rule masks representing the deliverability of packets across the edge;
(q) determining the deliverability of packets by computing the transitive closure of the directed graph of step (p) where the Boolean operators of Warshall's algorithm are applied to the arrays of Boolean values annotated at each edge;
(r) retrieving reachability for specific packet flows by means of a matrix of rule masks referencing the primary decomposition of the IP packet space;
(s) retrieving path information for specific packet flows by means of a directed graph annotated with rule masks and a reachability matrix of rule masks referencing the primary decomposition of the IP packet space; and
(t) retrieving the specific network device configuration elements that determined the deliverability or non-deliverability of specific packet flows by means of a directed graph annotated with rule masks and a reachability matrix of rule masks referencing the primary decomposition of the IP packet space.
